(19) United States
(12) Patent Application Publication
(10) Pub. No.: US 2004/0212744 A1
(43) Pub. Date: Oct. 28, 2004

(54) Television set having reinforced boss structure of cabinet for fixation of cathode ray tube

(76) Inventor: Takayuki Saitoh, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/830,321

(22) Filed: Apr. 23, 2004

(30) Foreign Application Priority Data
Apr. 25, 2003 (JP) 2003-121624

(51) Int. Cl. H04N 5/68

(52) U.S. Cl. 348/818; 348/805

(57) ABSTRACT

To cushion an impact acting on bosses to prevent the same from being transmitted to a cabinet body, a television set having reinforced boss structure of a cabinet for fixation of a cathode ray tube has ribs formed with notches, with thin-walled portions, with curved portions, or gaps are formed between ribs and inner wall surfaces of the cabinet so that an impact acting on the bosses is absorbed.

### BACKGROUND OF THE INVENTION

1. Field of the Invention

The present invention relates to a television set having reinforced boss structure provided on a cabinet to fix a cathode ray tube.

2. Related Art

A very heavy cathode ray tube (CRT) is mounted on a cabinet of a television set. A conventional cabinet is a frame made of a resin to be substantially quadrilateral in shape, and has an opening window, to which the cathode ray tube is mounted and in which a picture display is arranged. And, brackets extended from corners of the cathode ray tube are screwed to bosses provided on a cabinet front surface that is formed around the opening window.

The brackets of the cathode ray tube are screwed to threaded holes formed on the bosses. Since a structure, in which only the bosses stand upright from the front surface, is weak in strength, reinforcement ribs are formed between the bosses and inner wall surfaces of the cabinet. When deflection and deformation of the bosses are caused by a weight load of the cathode ray tube, however, the weight load is transmitted to the cabinet walls through the reinforcement ribs and the walls are deformed to change in color to become white.

Hereupon, “Television cabinet” according to JP-U-3073842 is known as solving the problem. This aims at preventing whitening of outer wall surfaces caused by deformation of walls of a cabinet around bosses for mounting of a cathode ray tube when a large load or an impact applies on the cabinet. Thus reinforcement ribs are provided on plate-shaped pieces that are provided in the vicinity of the bosses for mounting of a cathode ray tube. The bosses are arranged inside triangular structures, and brackets for mounting of a cathode ray tube are overlapped on the bosses and end surfaces of the structures to be clamped thereto by means of bolts.

Accordingly, the bosses surrounded by the triangular structures are increased in strength but become too high in rigidity to be lowered in the impact absorbing function, so that, for example, in the case of mounting a cathode ray tube of a large-sized television receiver of 20 inches or more, an impact as acting is very large to cause a fear that the triangular structures are partially cracked or occasionally broken. Such impact is frequently caused when a large-sized television receiver is unloaded from a truck, etc. in the case where a large-sized television receiver as packaged is transported.

Further, since the bosses are surrounded by the triangular structures, the reinforcement ribs are provided on the plate-shaped pieces of the triangular structures, and support pieces connecting between the bosses and the triangular structures and bearing pieces connecting between the triangular structures and side plates of the cabinet are formed, the surrounding of the bosses becomes complicate in shape, and manufacture of a molding die is not easy, so that the die is of course increased in cost. On the other hand, the die is decreased in life, which is reflected on the product cost.

Meanwhile, the triangular structures are provided around the bosses to result in complication, so that many materials for formation of a cabinet are required to sharply increase material cost. Further, since the triangular structures for mounting of a cathode ray tube are formed at corners of the cabinet, there is no surplus space at the corners and there is a need of taking care so as not to have an internal wiring erroneously caught in and broken at the time of mounting of a cathode ray tube, and it becomes occasionally necessary to use separate parts for handling of wiring.

In this manner, the problems described above are involved in a cabinet structure for mounting of a cathode ray tube.

### SUMMARY OF THE INVENTION

The invention aims at solving the problems and provides a television set having reinforced boss structure provided on a cabinet to fix a cathode ray tube, which is not complicate in shape but very simple to mount and support a cathode ray tube on bosses, and which cushions impact acting on the bosses and prevents the impact from being transmitted to the cabinet body.

The invention provides a boss reinforcement structure to reinforce ribs formed at corners of a cabinet for mounting of a very heavy cathode ray tube and to prevent impact acting on the bosses from being transmitted to wall bodies that constitute a cabinet body. Thus, the bosses are provided at respective corners of a cabinet to stand upright from a front surface, and ribs are provided to connect between inner wall surfaces of the cabinet and the bosses so as to reinforce the bosses. While the number of the ribs is not specifically limitative, the ribs can be generally provided in symmetric positions with respect to the bosses that stand upright at corners of a cabinet.

By the way, notches are formed on the ribs to absorb impact acting on the bosses. That is, even when an impact acting a very heavy cathode ray tube causes the bosses to bend and deform, it is absorbed by the notches so as not to be transmitted to walls of the cabinet through the ribs. Here, the notches are free in configuration and can be substantially V-shaped or substantially U-shaped, and the ribs can be partially thinned instead of the notches.

On the other hand, the ribs are formed in the form of not a flat surface but a wavy curved surface so that an impact is absorbed thereby to prevent from being transmitted to walls of a cabinet. Further, with a structure, in which ribs extended toward inner wall surfaces of a cabinet from the bosses are not connected to the inner wall surfaces but gaps are interposed therebetween, an impact acting on the bosses is not transmitted to walls of the cabinet. Embodiments of the invention will be described below in detail with reference to the drawings.

### BRIEF DESCRIPTION OF THE DRAWING

FIG. 1 is a perspective view showing an external appearance of a television receiver;

FIG. 2 is a plan view showing a reinforced boss structure of a cabinet for fixation of a cathode ray tube according to a first embodiment of the invention;

FIG. 3 is a cross sectional view taken along the line 3-3 in FIG. 2;

FIG. 4 is a plan view showing the reinforced boss structure of the cabinet with a cathode ray tube mounted thereto;

FIG. 5 is a perspective view showing a configuration, in which a substantially U-shaped notch is formed on the rib;

FIG. 6 is a perspective view showing a configuration, in which a substantially V-shaped notch is formed on the rib;

FIG. 7 is a perspective view showing a configuration, in which a thin-walled portion is formed on the rib;

FIG. 8 is a perspective view showing a configuration, in which a curved portion is formed on the rib;

FIG. 9 is a plan view showing a reinforced boss structure of a cabinet according to a second embodiment of the invention;

FIG. 10 is a plan view showing a reinforced boss structure of a cabinet according to a third embodiment of the invention;

FIG. 11 is a plan view showing a reinforced boss structure of a cabinet according to a fourth embodiment of the invention;

FIG. 12 is a plan view showing a reinforced boss structure of a cabinet according to a fifth embodiment of the invention;

FIG. 13 is a plan view showing a reinforced boss structure of a cabinet according to a sixth embodiment of the invention; and

FIG. 14 is a plan view showing a reinforced boss structure of a cabinet according to a seventh embodiment of the invention.

### DETAILED DESCRIPTION OF PREFERRED EMBODIMENT

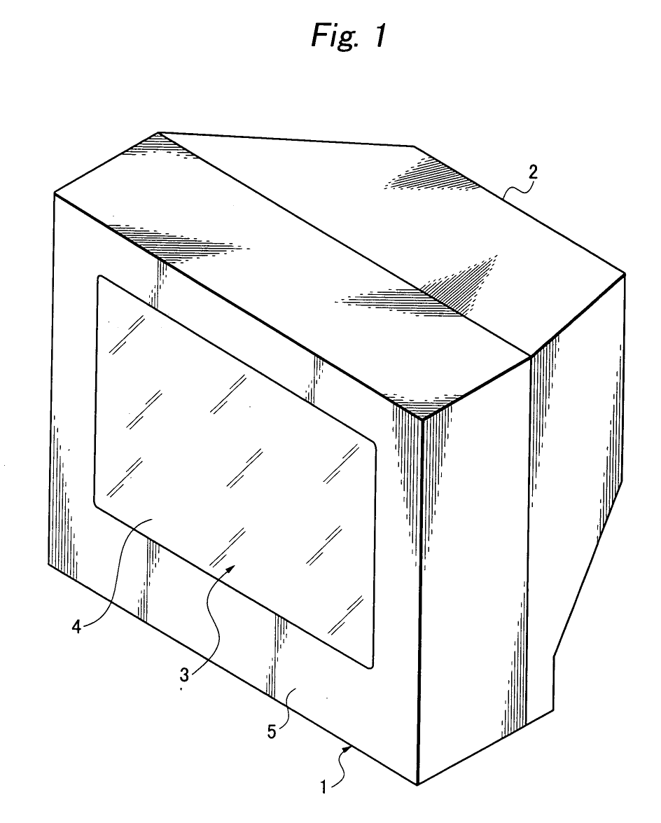

FIG. 1 shows an external appearance of a television receiver, and in the figure, the reference numeral 1 denotes a cabinet, 2 a back lid, and 3 a cathode ray tube (CRT). The cabinet 1 defines a quadrilateral frame, the cathode ray tube 3 is mounted in the cabinet 1, and a picture display 4 of the cathode ray tube 3 is fitted into an opening window on a cabinet front surface 5.

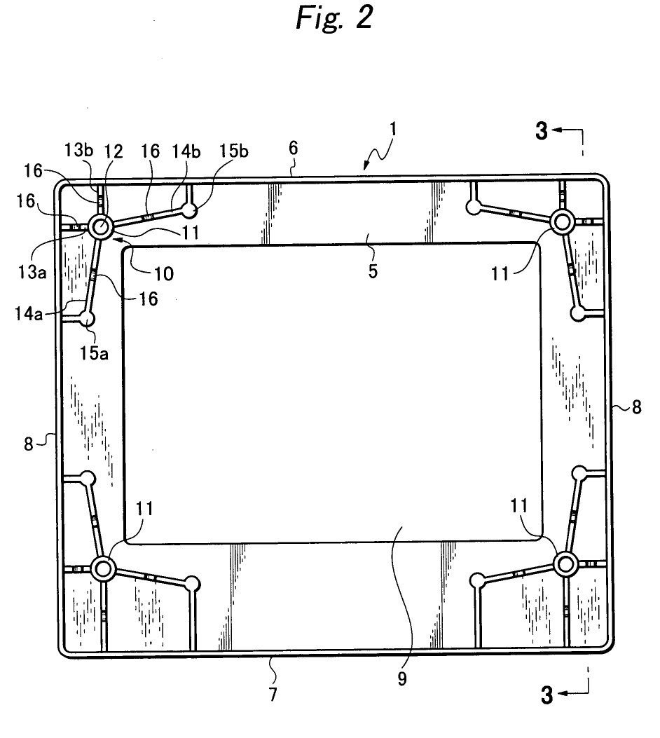

FIG. 2 shows a first embodiment of a boss reinforcement structure of a cabinet according to the invention and a rear side of the cabinet 1. The cabinet 1 is a molding made of a resin to be in the form of a rectangular frame, and comprises an upper surface 6, a lower surface 7, and both side surfaces 8, 8, the cabinet being fully opened at a rear side thereof and formed at a front surface 5 thereof with an opening window 9, into which the picture display of the cathode ray tube is fitted. And, bosses 11, 11, . . . are provided on respective comers 10, 10, . . . of the cabinet 1, which comprises a rectangular frame, to stand vertically upright on the front surface 5, and threaded holes 12 are formed on the bosses 11.

While brackets extended from corners of the cathode ray tube are screwed onto the bosses 10, various ribs shown in the figure are provided since the heavy cathode ray tube cannot be supported only by the four bosses 11, 11, . . . that stand upright from the front surface 5. In the embodiment shown in the figure, four ribs are provided to be connected to inner wall surfaces of the cabinet. The four ribs comprise ribs 13a, 13b provided near to the corner 10 of the cabinet 1, and ribs 14a, 14b connected to the inner wall surfaces in positions away from the corner 10. The ribs 14a, 14b connect the boss 11 and the inner wall surfaces of the cabinet to each other with struts 15a, 15b therebetween, the struts standing upright from the front surface 5.

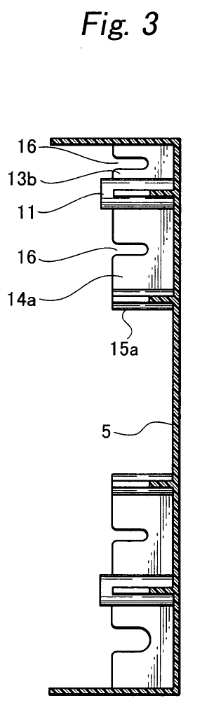

The ribs 13a, 13b are provided at intermediate portions thereof with notches 16, 16, and the ribs 14a, 14b are likewise provided with notches 16, 16. FIG. 3 shows a cross section taken along the line 3-3 in FIG. 2, and the notches 16, 16 are formed to extend from upper edges of the ribs 13b, 14a. As apparent from the figure, the boss 11 is higher than the ribs 13a, 13b, 14a, 14b, and the struts 15 are as high as the ribs 13a, 13b, 14a, 14b.

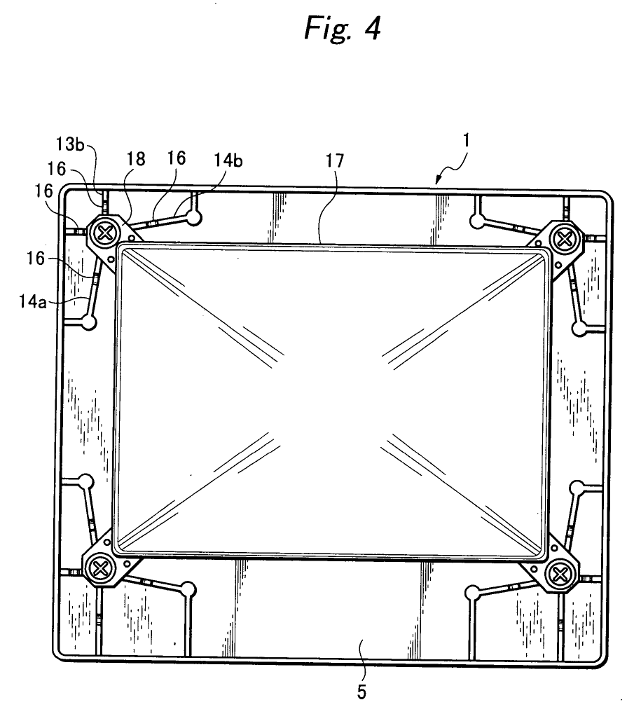

FIG. 4 shows a state, in which the cathode ray tube 17 is mounted on the cabinet 1. The cathode ray tube 17 defines a slightly larger rectangle than the opening window 9 on the front surface 5, and brackets 18, 18, . . . extend outward from corners of the cathode ray tube, and are screwed to the bosses 11, 11, . . . . Here, a weight of the cathode ray tube 17 can be shared and born by the bosses 11 and the respective ribs 13a, 13b, 14a, 14b.

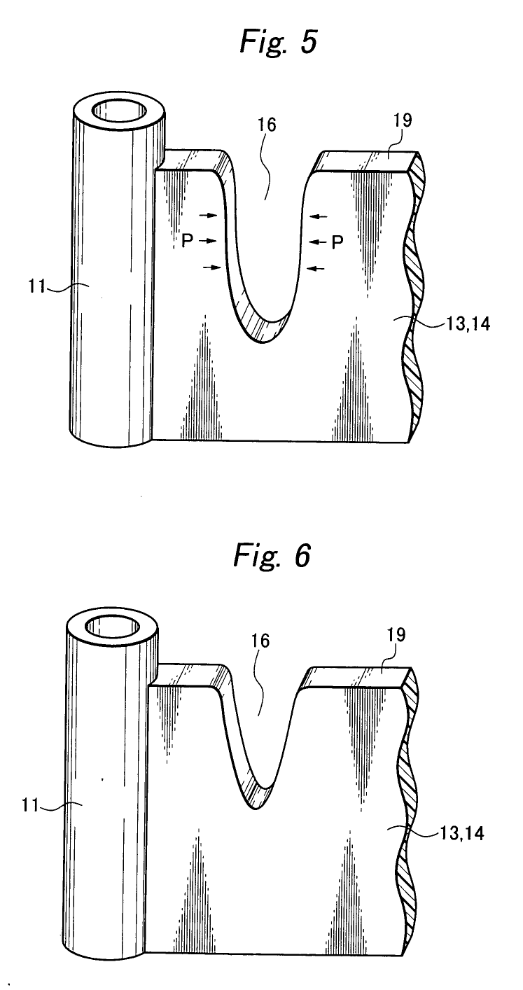

FIG. 5 shows a concrete example of a notch 16 formed in the rib 13, 14, the notch 16 being cut out from the upper edge 19 of the rib 13, 14 to define a substantially U-shape. Here, the brackets 18 of the cathode ray tube 17 are screwed and fixed to the bosses 11, and when a weight of the cathode ray tube 17 acts on the bosses 11 and, for example, a rightward impact is generated at the time of loading and unloading of a load during transportation, the impact is transmitted to the ribs 13, 14. And, the notches 16 formed in the ribs 13, 14 are compressed to be able to restrict transmission to walls of the cabinet.

That is, formation of the notches 16 in the ribs 13, 14 causes the ribs there to be reduced in strength, and an impulsive force acting on the bosses 11 can be absorbed due to compression and deformation of the notches 16. Of course, an impulsive force in a leftward direction causes the notches 16 to be pulled to be subjected to enlargement and deformation. However, a static load acting to bear the cathode ray tube 17 will not cause compression and tension deformation of the notches 16.

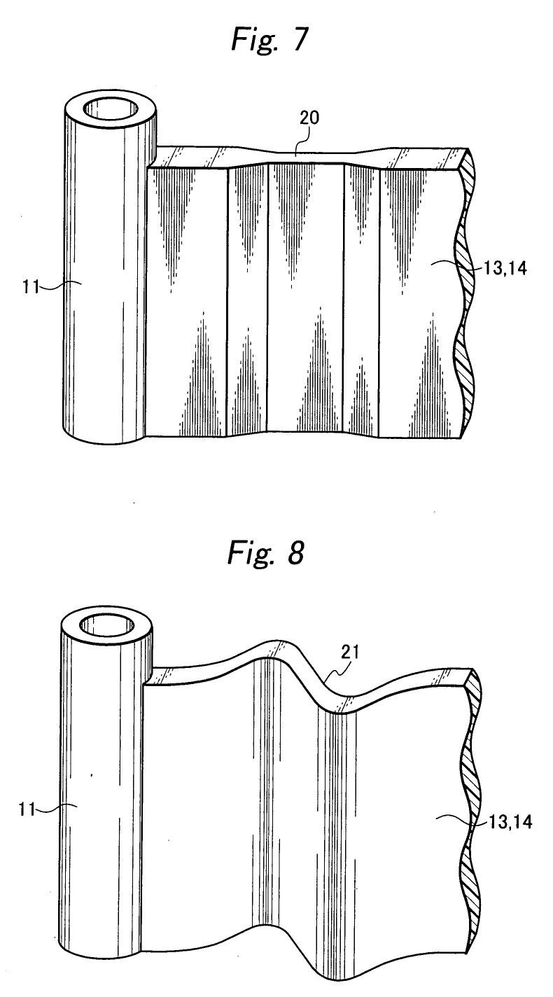

FIG. 6 shows the case where a substantially V-shaped notch 16 is formed on the rib 13, 14. This case is the same in function and effect as the case of the substantially U-shaped notches shown in FIG. 5. Further, FIG. 7 shows a further embodiment of the invention, in which a thin-walled portion 20 is partially formed on the rib 13, 14. Accordingly, the thin-walled portion 20 is reduced in strength, and the thin-walled portion 20 is compressed or pulled by an impact acting on the boss 11. Accordingly, since the thin-walled portion 20 absorbs an impact, it is possible to restrict its influence on the walls of the cabinet.

FIG. 8 shows the case where a curved portion 21 is formed on the rib 13, 14. Formation of the curved portion 21 on the rib 13, 14 leads to easy bending deformation even when the curved portion is the same in wall thickness as the other portions. Accordingly, in the case where an impact acts on the boss 11, the rib is not deformed as a whole but compressive or tensile stresses acting on the rib 13, 14 generate a bending moment in the curved portion 21, which moment causes bending deformation to absorb the impact.

The notches, the thin-walled portions, and the curved portions formed on the ribs cushion an impact to enable restricting transmission of the impact to the walls of the cabinet, and a combination of the notches, the thin-walled portions, and the curved portions can be used.

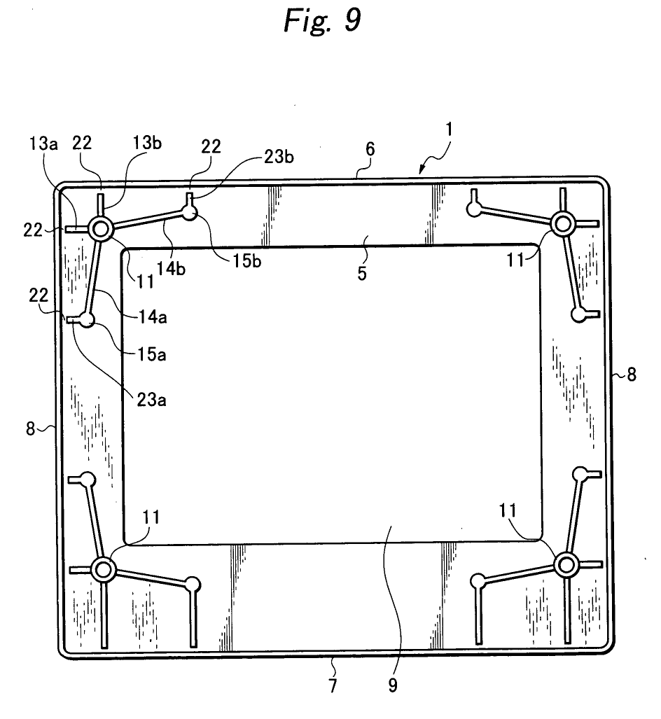

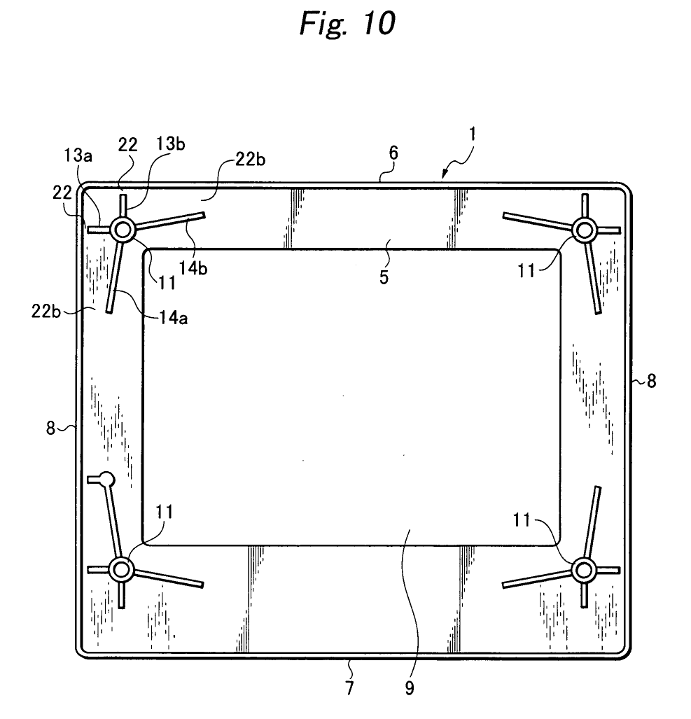

FIG. 9 shows a second embodiment according to the invention, which is common to the boss reinforcement structure shown in FIG. 2. In this embodiment, however, ribs 13a, 13b are not connected to inner wall surfaces of a cabinet with gaps 22, 22 therebetween, and auxiliary ribs 23a, 23b extending from struts 15a, 15b provided at tip ends of ribs 14, 14b are also not connected to the inner wall surfaces of the cabinet with gaps 22, 22 therebetween. The gaps 22, 22, . . . correspond to the notches 16, 16, . . . illustrated in the previous embodiment and stresses acting on the respective ribs 13a, 13b, 14a, 14b are cut off by the gaps 22, 22, . . . and not transmitted to walls of the cabinet.

FIG. 10 shows a third embodiment of a boss reinforcement structure similar to that shown in FIG. 9. Bosses 11 are provided at corners of a cabinet to stand upright from a front surface 5 of the cabinet, and ribs 13a, 13b, 14a, 14b are extended outward from the bosses 11. However, the ribs 13a, 13b, 14a, 14b are not connected to inner wall surfaces of the cabinet, and gaps 22 and spaces 22a are formed therebetween.

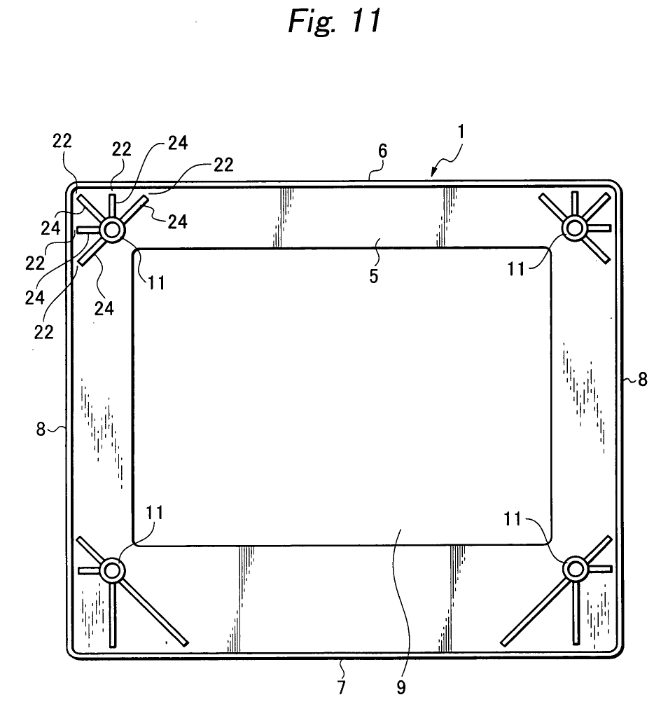

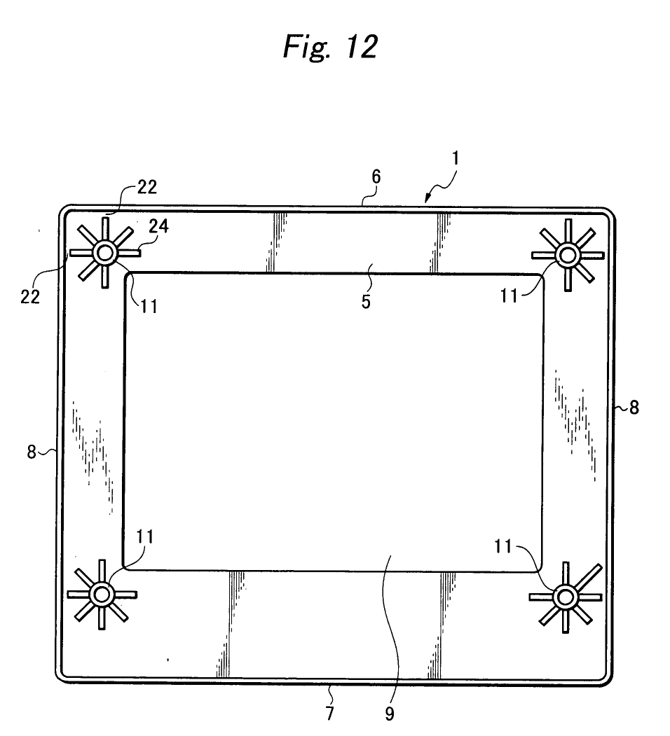

FIG. 11 shows a fourth embodiment, in which ribs 24, 24, . . . are extended radially outward from ribs 11 as centers. However, gaps 22, 22, . . . are interposed between the respective ribs 24, 24, . . . and inner wall surfaces of a cabinet. With an embodiment shown in FIG. 12, ribs 24, 24, . . . are extended radially all around bosses 11 and tip ends of the respective ribs are not connected to inner wall surfaces of a cabinet.

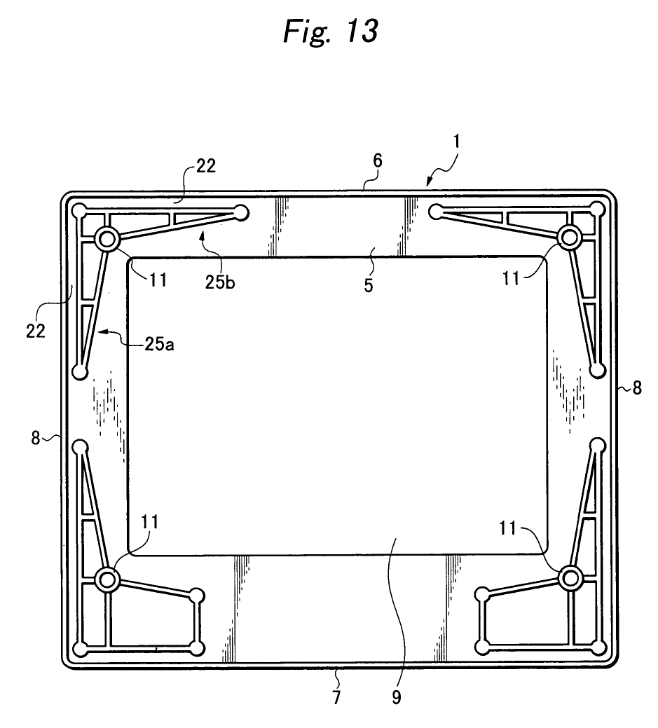

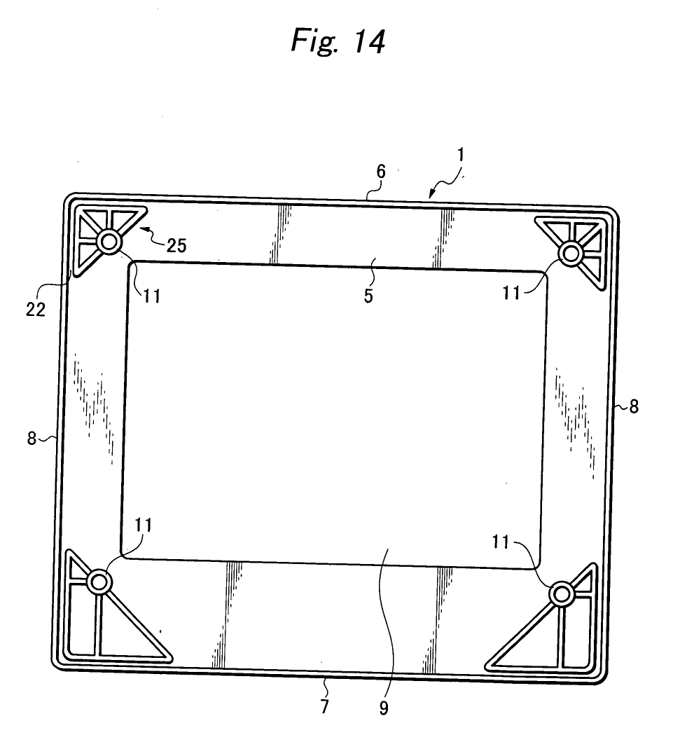

FIG. 13 shows a sixth embodiment, in which reinforcement structures 25a, 25b formed by a combination of respective ribs are provided around a boss 11. The reinforcement structures 25a, 25b include gaps 22, 22 between them and inner wall surfaces of a cabinet. Accordingly, even when the reinforcement structures 25a, 25b are deformed by a load that acts on the boss 11, such deformation does not have an influence on walls of the cabinet. In an embodiment shown in FIG. 14, a reinforcement structure 25 is likewise provided on a boss 11.

As described above, with the television set having reinforced boss structure of a cabinet for fixation of a cathode ray tube according to the invention, ribs are provided around bosses that stand upright from a front surface of a cabinet, and connected to inner wall surfaces of the cabinet, notches or thin-walled portions are formed on the ribs, or gaps are provided between ribs and inner wall surfaces of the cabinet, the reinforcement structure enabling producing the following effects.

With the television set having reinforced boss structure of a cabinet for fixation of a cathode ray tube according to the invention, ribs are provided around bosses that stand upright from a front surface of a cabinet, and connected to inner wall surfaces of the cabinet, and notches or thin-walled portions are formed on the ribs. Accordingly, in the case where a large impact acts on bosses, to which a very heavy cathode ray tube is mounted, the bosses bend and deform and such bending and deformation are transmitted to reinforcement ribs extended from the bosses but notches, thin-walled portions, or curved portions formed on the ribs can absorb the impact.

Also, the ribs extended from the bosses are not connected to inner wall surfaces of the cabinet but gaps are formed therebetween whereby it is possible to produce the same function and effect as those produced with the notches. Accordingly, the walls of the cabinet are restricted in deformation, so that it is possible to prevent outer wall surfaces of the cabinet from being susceptible of whitening. Also, the television set having reinforced boss structure of a cabinet for fixation of a cathode ray tube according to the invention involves only formation of notches on ribs or provision of thin-walled portions on ribs, and is simple in configuration, that is, there is no need of providing a multiplicity of small ribs around bosses, a molding die and the manufacturing cost are inexpensive, and the molding die is extended in life.

Meanwhile, the notches formed on the ribs are made use of to enable receiving/handling, for example, wire materials that connect an operating substrate and a speaker together. Accordingly, a cathode ray tube can be mounted to a cabinet without having the wire materials getting in the way, so that an improvement in workability is achieved at the time of assembly.

What is claimed is:

1. A television set having reinforced boss structure of a cabinet for fixation of a cathode ray tube, comprising bosses for mounting of the cathode ray tube, the bosses being provided upright at respective corners of the cabinet, and ribs provided to be connected to inner wall surfaces of the cabinet to reinforce the bosses, wherein the ribs are formed with notches.

2. A television set having reinforced boss structure of a cabinet for fixation of a cathode ray tube, comprising bosses for mounting of the cathode ray tube, the bosses being provided upright at respective corners of the cabinet, and ribs provided to be connected to inner wall surfaces of the cabinet to reinforce the bosses, wherein the ribs are formed with thin-walled portions.

3. A television set having reinforced boss structure of a cabinet for fixation of a cathode ray tube, comprising bosses for mounting of the cathode ray tube, the bosses being provided upright at respective corners of the cabinet, and ribs provided to be connected to inner wall surfaces of the cabinet to reinforce the bosses, wherein the ribs are formed with curved portions.

4. A television set having reinforced boss structure of a cabinet for fixation of a cathode ray tube, comprising bosses for mounting of the cathode ray tube, the bosses being provided upright at respective corners of the cabinet, and ribs extended outward to reinforce the bosses, wherein gaps are formed between the ribs and inner wall surfaces of the cabinet.

5. A television set having reinforced boss structure of a cabinet for fixation of a cathode ray tube, comprising bosses for mounting of the cathode ray tube, the bosses being provided upright at respective corners of the cabinet, and reinforcement structures formed by combining respective ribs and for reinforcement of the bosses, wherein gaps are formed between the reinforcement structures and inner wall surfaces of the cabinet.
